(19) United States
(12) Patent Application Publication
(10) Pub. No.: US 2025/0364595 A1
(43) Pub. Date: Nov. 27, 2025

(54) ELECTROLYTE SOLUTION FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Aehui GOH, Yongin-si (KR); Minji SIM, Yongin-si (KR); Inah KANG, Yongin-si (KR); Hanmam JEONG, Yongin-si (KR); Hongjin LIM, Yongin-si (KR); SiYoung CHA, Yongin-si (KR); Myungheui WOO, Yongin-si (KR)

(73) Assignee: SAMSUNG SDI CO., LTD., Yongin-si (KR)

(21) Appl. No.: 19/079,909

(22) Filed: Mar. 14, 2025

(30) Foreign Application Priority Data
May 23, 2024 (KR) 10-2024-0066844

(51) Int. Cl. H01M 10/0567; H01M 4/58; H01M 10/052; H01M 10/0569

(52) U.S. Cl. CPC H01M 10/0567; H01M 4/5825; H01M 10/052; H01M 10/0569; H01M 2300/004

(57) ABSTRACT

Examples of the disclosure include an electrolyte solution for a rechargeable lithium battery, and a rechargeable lithium battery including the electrolyte solution. The electrolyte solution includes a non-aqueous organic solvent, a lithium salt, a first additive, and a second additive capable of ring-opening the first additive, and the content ratio of the second additive to the first additive is about 1 to about 3.

### CROSS-REFERENCE TO RELATED APPLICATIONS

This U.S. non-provisional patent application claims priority under 35 U.S.C. § 119 of Korean Patent Application No. 10-2024-0066844, filed on May 23, 2024, the entire contents of which are hereby incorporated by reference.

### BACKGROUND

Examples of the present disclosure relate to an electrolyte solution for a rechargeable lithium battery, and ta rechargeable lithium battery including the electrolyte solution.

The increased use of battery-powered electronics, such as, e.g., mobile phones, laptop computers, electric vehicles, and the like, has driven a sharp rise in demand for rechargeable batteries provided with high energy density and high capacity.

Rechargeable lithium batteries typically include a positive electrode and a negative electrode, each of the positive electrode and the negative electrode including an active material that allows intercalation and deintercalation of lithium ions, and an electrolyte solution, and produce electrical energy from redox reactions that take place as lithium ions are intercalated into or deintercalated from the positive electrode and the negative electrode.

In an example, a lithium salt is dissolved in a non-aqueous organic solvent to form an electrolyte of the rechargeable lithium batteries. The rechargeable lithium batteries exhibit characteristics thereof through complex reactions between the positive electrode and the electrolyte, and between the negative electrode and the electrolyte. Thus, the use of an appropriate electrolyte is a compelling element in improving performance of the rechargeable lithium batteries.

### SUMMARY

Examples of the present disclosure include an electrolyte solution for a rechargeable lithium battery, the electrolyte solution having improved stability and lifetime characteristics at high temperatures.

Examples of the present disclosure also include a rechargeable lithium battery including the electrolyte solution.

An example embodiment of the present disclosure includes an electrolyte solution for a rechargeable lithium battery including a non-aqueous organic solvent, a lithium salt, a first additive represented by Formula 1 below, and a second additive capable of ring-opening the first additive, wherein the content ratio of the second additive to the first additive is about 1 to about 3.

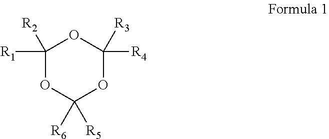

In Formula 1 above,

R₁ to R₆ may each independently be or include a hydrogen atom or a substituted or unsubstituted C1 to C10 alkyl group.

In an example embodiment of the present disclosure, a rechargeable lithium battery includes a positive electrode including a positive electrode active material, a negative electrode including a negative electrode active material, and an electrolyte solution, wherein the electrolyte solution includes at least one of a non-aqueous organic solvent, a lithium salt, a first additive represented by Formula 1 described above, and a second additive capable of ring-opening the first additive described above. In the electrolyte solution, the content ratio of the second additive to the first additive may be about 1 to about 3.

### BRIEF DESCRIPTION OF THE FIGURES

The accompanying drawings are included to provide a further understanding of the present disclosure, and are incorporated in and constitute a part of this specification. The drawings illustrate example embodiments of the present disclosure and, together with the description, explain principles of the present disclosure. In the drawings:

FIG. 1 is a simplified conceptual view illustrating a rechargeable lithium battery, according to example embodiments of the present disclosure; and

FIGS. 2 to 5 are cross-sectional views schematically illustrating a rechargeable lithium battery according to an example embodiment.

### DETAILED DESCRIPTION

In order to sufficiently understand the configuration and effects of the present disclosure, example embodiments of the present disclosure will be described with reference to the accompanying drawings. It should be noted, however, that the present disclosure is not limited to the following example embodiments, and may be implemented in various forms and variously modified. The example embodiments herein are provided so that the present disclosure will be thorough and will fully convey the scope of the present disclosure to those skilled in the art.

Herein, it will be understood that when a component is referred to as being “on” another component, the component may be directly on another component, or an intervening third component may be present. In addition, in the drawings, thicknesses of components are exaggerated for effectively describing technical contents. Like reference numerals refer to like elements throughout.

Unless otherwise specified herein, the expression of singular form may include the expression of plural form. In addition, unless otherwise specified, the phrase “A or B” may indicate “A but not B,” “B but not A,” or “A and B.” The terms “comprises” and/or “comprising” used herein do not exclude the presence or addition of one or more other components.

As used herein, the term “combination thereof” may refer to a mixture, a stack, a composite, a copolymer, an alloy, a blend, or a reaction product.

Herein, unless otherwise defined, “substitution” indicates that at least one hydrogen in a substituent or compound is substituted with deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, or a combination thereof.

For example, the “substitution” may indicate that at least one hydrogen in a substituent or compound is substituted with deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, the “substitution” may indicate that at least one hydrogen in a substituent or compound is substituted with deuterium, a halogen group, a C1 to C20 alkyl group, a C6 to C30 aryl group, a C1 to C10 fluoroalkyl group, or a cyano group. In addition, the “substitution” may indicate that at least one hydrogen in a substituent or compound is substituted with deuterium, a halogen group, a C1 to C5 alkyl group, a C6 to C18 aryl group, a C1 to C5 fluoroalkyl group, or a cyano group. For example, the “substitution” may indicate that at least one hydrogen in a substituent or compound is substituted with deuterium, a cyano group, a halogen group, a methyl group, an ethyl group, a propyl group, a butyl group, a phenyl group, a biphenyl group, a terphenyl group, a trifluoromethyl group, or a naphthyl group.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

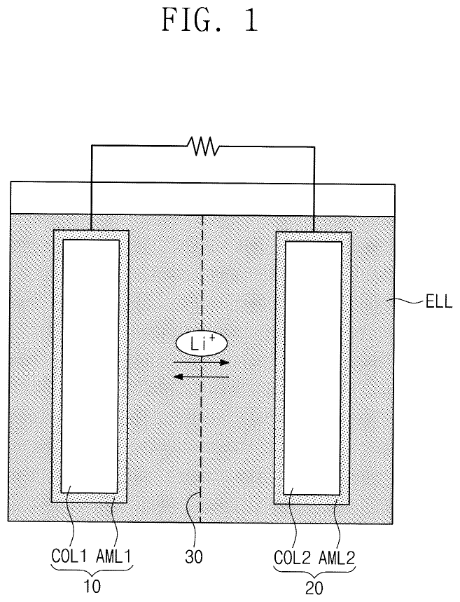

FIG. 1 is a cross-sectional view of a rechargeable lithium battery according to example embodiments of the present disclosure. Referring to FIG. 1, the rechargeable lithium battery may include a positive electrode 10, a negative electrode 20, a separator 30, and an electrolyte solution ELL.

The positive electrode 10 and the negative electrode 20 may be spaced apart from each other by the separator 30. The separator 30 may be disposed between the positive electrode 10 and the negative electrode 20. The positive electrode 10, the negative electrode 20 and the separator 30 may be in contact with the electrolyte solution ELL. The positive electrode 10, the negative electrode 20 and the separator 30 may be impregnated in the electrolyte solution ELL.

The electrolyte solution ELL may be or include a medium for transferring lithium ions between the positive electrode 10 and the negative electrode 20. In the electrolyte solution ELL, the lithium ions may move through the separator 30 toward the positive electrode 10 or the negative electrode 20.

### Positive Electrode 10

The positive electrode 10 for a rechargeable lithium battery may include a current collector COLI and a positive electrode active material layer AML1 on the current collector.

The positive electrode active material layer AML1 may include a positive electrode active material, and may further include a binder and/or a conductive material (e.g., an electrically conductive material).

For example, the positive electrode 10 may further include an additive that can constitute a sacrificial positive electrode.

An amount or concentration of the positive electrode active material may be about 90 wt % to about 99.5 wt % based on 100 wt % of the positive electrode active material layer AML1. Amounts or concentrations of the binder and the conductive material may be about 0.5wt % to about 5 wt %, respectively, based on 100 wt % of the positive electrode active material layer AML1 .

The binder is configured to attach the positive electrode active material particles to each other, and also to attach the positive electrode active material to the current collector COL1. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth) acrylated styrene-butadiene rubber, an epoxy resin, a (meth) acrylic resin, a polyester resin, nylon, and the like, as non-limiting examples.

The conductive material may be configured to impart conductivity (e.g., electrical conductivity) to the electrode. Any material that does not cause a chemical change (e.g., that does not cause an undesirable chemical change in the rechargeable lithium battery), and that conducts electrons, can be used in the battery. Examples of the conductive material may include a carbon-based material such as or including at least one of natural graphite, artificial graphite, carbon black, acetylene black, ketjen black, a carbon fiber, a carbon nanofiber, and carbon nanotube; a metal-based material containing at least one of copper, nickel, aluminum, silver, etc., in a form of a metal powder or a metal fiber; a conductive polymer such as a polyphenylene derivative; or a mixture thereof.

Al may be included in the current collector COL1, but is not limited thereto.

### Positive Electrode Active Material

The positive electrode active material may include a compound (lithiated intercalation compound) that is capable of intercalating and deintercalating lithium. For example, at least one of a composite oxide of lithium and a metal including at least one of cobalt, manganese, nickel, and combinations thereof may be included in the positive electrode active material.

The composite oxide may be or include a lithium transition metal composite oxide. Examples of the composite oxide may include at least one of lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiₐA_{1- b}X_{b}O_{2- c}D_{c} (0.90≤a≤1.8, 0≤b≤0.5, and 0 ≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α}(0.90≤a≤1.8, 0≤b≤0.5, 0≤c≤0.5, and 0<α<2); LiₐNi_{1-b-c}Mn_{b}X_{c}O_{2-α}Dα (0.90≤a≤1.8, 0≤b≤0.5, 0≤c≤0.5, and 0<α<2); LiₐNi_{b}Co_{c}L¹dGeO₂ (0.90≤a≤1.8, 0≤b≤0.9, 0≤c≤0.5, 0≤d≤0.5, and 0≤e≤0.1); LiₐNiG_{b}O_{2 2} (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is or includes at least one of Ni, Co, Mn, or a combination thereof; X is or includes at least one of Al, Ni, Co, Mn, Cr, Fe, Mg, Sr, V, a rare earth element or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn and Al, or a combination thereof.

The positive electrode active material may be or include, for example, a high nickel-based positive electrode active material having a nickel content of greater than or equal to about 80 mol %, greater than or equal to about 85 mol %, greater than or equal to about 90mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

### Negative Electrode 20

The negative electrode 20 for a rechargeable lithium battery may include a current collector COL2, and a negative electrode active material layer AML2 on the current collector COL2. The negative electrode active material layer AML2 may include a negative electrode active material, and may further include a binder and/or a conductive material (e.g., an electrically conductive material).

For example, the negative electrode active material layer AML2 may include about 90 wt % to about 99 wt % of the negative electrode active material, about 0.5 wt % to about 5 wt % of the binder, and about 0 wt % to about 5 wt % of the conductive material.

The binder may be configured to attach the negative electrode active material particles to each other and also to attach the negative electrode active material to the current collector COL2. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be or include at least one of a styrene-butadiene rubber, a (meth) acrylated styrene-butadiene rubber, a (meth) acrylonitrile-butadiene rubber, (meth) acrylic rubber, a butyl rubber, a fluoro rubber, polyethylene oxide, polyvinylpyrrolidone, polyepichlorohydrine, polyphosphazene, poly (meth) acrylonitrile, an ethylene propylene diene copolymer, polyvinylpyridine, chlorosulfonated polyethylene, latex, a polyester resin, a (meth) acrylic resin, a phenol resin, an epoxy resins, polyvinyl alcohol, and a combination thereof.

When an aqueous binder is the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be or include a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

The conductive material may be configured to impart conductivity (e.g., electrical

conductivity) to the electrode. Any material that does not cause a chemical change (e.g., that does not cause an undesirable chemical change in the rechargeable lithium battery), and that conducts electrons, can be used in the battery. Non-limiting examples thereof may include a carbon-based material such as or including at least one of natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

The negative current collector COL2 may include at least one of a copper foil, a nickel foil, a stainless steel foil, a titanium foil, a nickel foam, a copper foam, a polymer substrate coated with a conductive metal, or a combination thereof.

### Negative Electrode Active Material

The negative electrode active material may include at least one of a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon or a combination thereof. The crystalline carbon may be or include graphite such as non-shaped, sheet-shaped, flake-shaped, sphere-shaped, or fiber-shaped natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include silicon, a silicon-carbon composite, SiOₓ (0≤×≤2), a Si-Q alloy (where Q is or includes at least one of an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include at least one of Sn, SnO₂, a Sn-based alloy, or a combination thereof.

The silicon-carbon composite may be or include a composite of silicon and amorphous carbon. According to an example embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be combined with a carbon-based negative electrode active material.

### Separator 30

Depending on the type of the rechargeable lithium battery, the separator 30 may be between the positive electrode 10 and the negative electrode 20. The separator 30 may include at least one of polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator 30 may include a porous substrate and a coating layer including an organic material, an inorganic material, or a combination thereof on one surface or on both surfaces of the porous substrate.

The porous substrate may be or include a polymer film formed of or including any one polymer polyolefin such as at least one of polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof. The organic material may include a polyvinylidene fluoride-based polymer or a (meth) acrylic polymer.

The inorganic material may include inorganic particles including at least one of Al₂O₃, Si₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto. The organic material and the inorganic material may be mixed in one coating

layer, or a coating layer including an organic material and a coating layer including an inorganic material may be stacked.

### Electrolyte Solution ELL

The electrolyte solution ELL for a rechargeable lithium battery may include a

non-aqueous organic solvent and a lithium salt.

The non-aqueous organic solvent may constitute a medium for transmitting ions taking part in the electrochemical reaction of a battery.

The non-aqueous organic solvent may be or include at least one of a carbonate- based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include at least one of ethanol, isopropyl alcohol, and the like, and the aprotic solvent may include at least one of nitriles such as R—CN (wherein R is a C2 to C20 linear, branched, or cyclic hydrocarbon group, a double bond, an aromatic ring, or an ether bond, and the like); amides such as dimethylformamide; dioxolanes such as 1,3-dioxolane, 1,4-dioxolane, and the like; and sulfolanes, and the like.

The non-aqueous organic solvents may be used alone or in combination of two or more solvents.

In addition, when the solvent is a carbonate-based solvent, a cyclic carbonate and

a chain carbonate may be mixed, and the cyclic carbonate and the chain carbonate may be mixed in a volume ratio of about 1:1 to about 1:9.

The lithium salt dissolved in the organic solvent supplies lithium ions in a battery, enables a basic operation of a rechargeable lithium battery, and improves transportation of the lithium ions between positive and negative electrodes. Examples of the lithium salt include at least one of LiPF₆, LiBF₄, LiSbF₆, LiAsF₆, LiClO₄, LiAlO₂, LiAlCl₄, LIPO₂F₂, LiCl, LiI, LiN(SO₃C₂F₅)₂, Li(FSO₂)₂N (lithium bis(fluorosulfonyl) imide, LiFSI), LiC₄F₉SO₃, LiN(CₓF₂ₓ₊₁SO₂)(C_{y}F_{2y+1}SO₂) (wherein x and y are integers of 1 to 20), lithium trifluoromethane sulfonate, lithium tetrafluoroethanesulfonate, lithium difluoro (oxalato) borate (LiDFOB), lithium difluorobis (oxalato) phosphate (LiDFBOP), and lithium bis(oxalato) borate (LiBOB).

### Rechargeable Lithium Battery

The rechargeable lithium battery may be classified into cylindrical, prismatic,

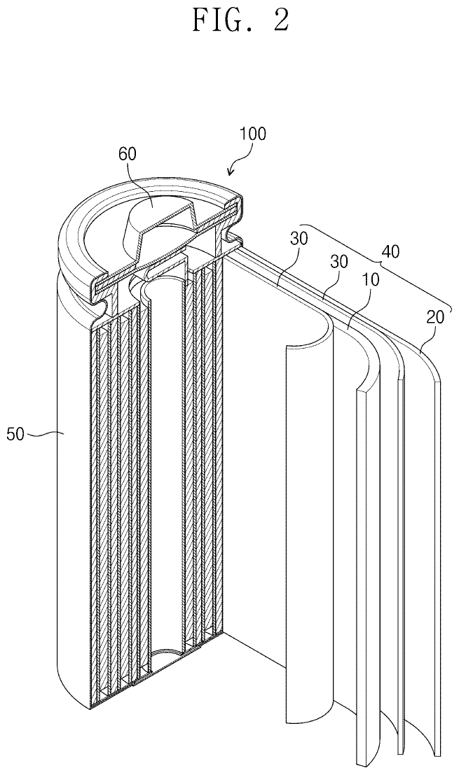

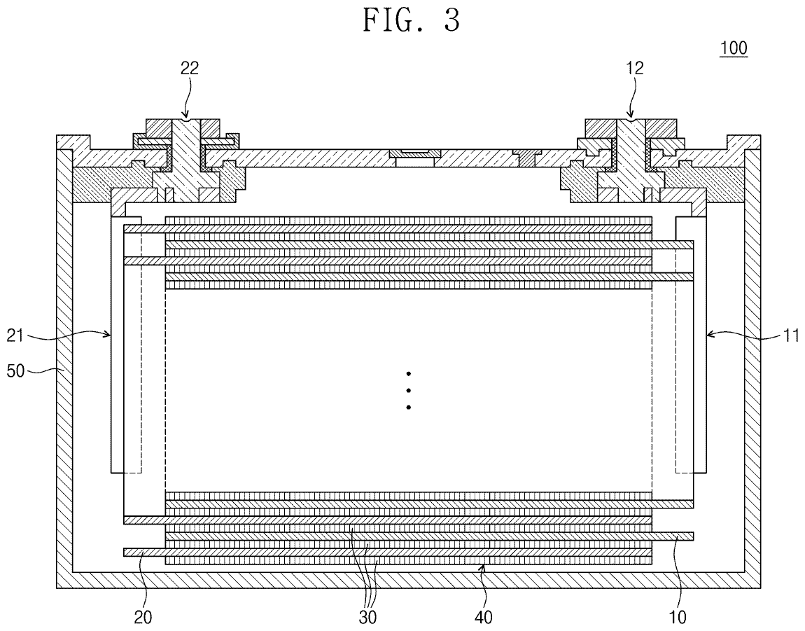

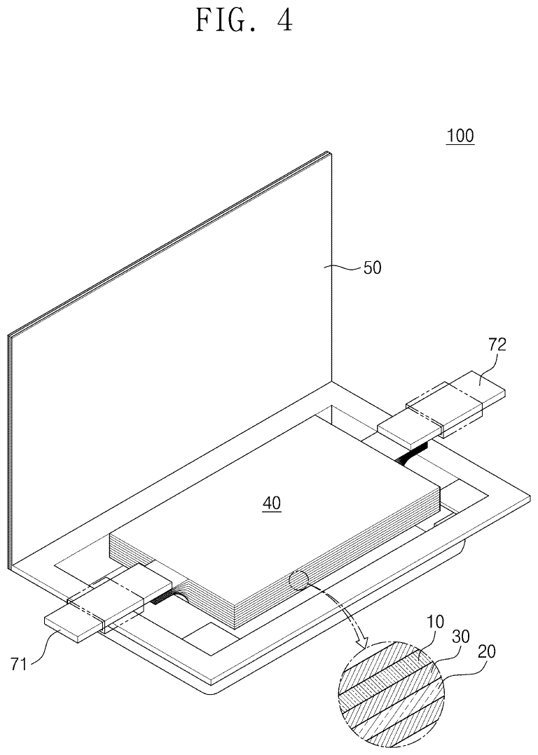

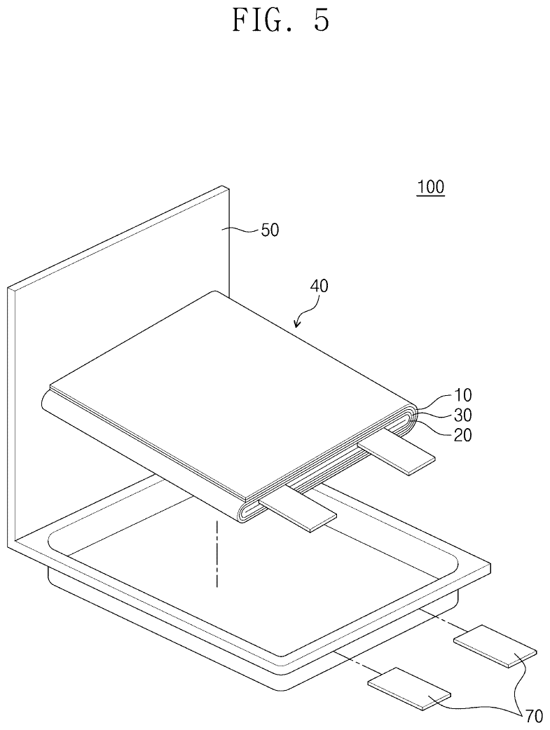

pouch, or coin-type batteries, and the like depending on their shape. FIGS. 2 to 5 are schematic views illustrating a rechargeable lithium battery according to an example embodiment. FIG. 2 shows a cylindrical battery, FIG. 3 shows a prismatic battery, and FIGS. 4 and 5 show pouch-type batteries. Referring to FIGS. 2 to 5, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution (not shown). The rechargeable lithium battery 100 may include a sealing member 60 sealing the case 50, as illustrated in FIG. 2. In FIG. 3, the rechargeable lithium battery 100 may include a positive lead tab 11, a positive terminal 12, a negative lead tab 21, and a negative terminal 22. As shown in FIGS. 4 and 5, the rechargeable lithium battery 100 may include an electrode tab 70 illustrated in FIG. 5, and, for example, a positive electrode tab 71 and a negative electrode tab 72 illustrated in FIG. 4, the tabs 70/71/72 forming an electrical path for inducing the current formed in the electrode assembly 40 to the outside of the battery 100.

Hereinafter, an electrolyte solution of a rechargeable lithium battery according to example embodiments of the present disclosure will be described in more detail.

The electrolyte solution for a rechargeable lithium battery according to an example embodiment may include a non-aqueous organic solvent, a lithium salt, a first additive represented by Formula 1 below which will be described later, and a second additive capable of ring-opening the first additive which will be described later.

The electrolyte solution may be prepared by a method through a mixing process in which a lithium salt is dissolved in a non-aqueous organic solvent, and the first additive and the second additive are added. The process of mixing the electrolyte solution is widely known in the field of electrolyte solution preparation, and will be appropriately selected by a person skilled in the art.

The non-aqueous organic solvent may include at least one of ethylene carbonate (EC), propylene carbonate (PC), propyl propionate (PP), ethyl methyl carbonate (EMC), dimethyl carbonate (DMC), diethyl carbonate (DEC), dipropyl carbonate (DPC), methylpropyl carbonate (MPC), ethylpropyl carbonate (EPC), methylethyl carbonate (MEC), and butylene carbonate (BC).

In an example embodiment, the non-aqueous organic solvent may be or include at least one of a mixed solvent of ethylene carbonate (EC), propylene carbonate (PC), and propyl propionate (PP). The ethylene carbonate (EC), the propylene carbonate (PC), and the propyl propionate (PP) may be present at a volume ratio of 1: a: b, where “a” may be in a range of about 1 to about 3, and “b” may be in a range of about 5 to about 8.

As a specific example, the ethylene carbonate (EC) may be included in an amount of about 5 vol % to about 20 vol % with respect to a total amount of the non-aqueous organic solvent. The propylene carbonate (PC) may be included in an amount of about 10 vol % to about 30 vol % with respect to the total amount of the non-aqueous organic solvent. The propyl propionate (PP) may be included in an amount of about 50 vol % to about 80 vol % with respect to the total amount of the non-aqueous organic solvent.

The lithium salt may be or include at least one of LiPF₆, LiSbF₆, LiAsF₆, LiClO₄, LiAlO₂, LiAlCl₄, LiPO₂F₂, LiCl, LiI, LIN(SO₃C₂F₅)₂, Li(FSO₂)₂N, (lithium bis(fluorosulfonyl)imide (LiFSI)), and LiC₄F₉SO₃. According to an example embodiment, LiPF₆ may be or included in the lithium salt.

The lithium salt may have a concentration of about 0.1 M to about 2.0 M. For example, the lithium salt may have a concentration of about 0.5 M or greater, or a concentration of about 1.0 M or greater. The lithium salt may have a concentration of about 2.0 M or less, about 1.7 M or less, or about 1.5 M or less. In the present disclosure, when the lithium salt has a concentration of about 0.1 M to about 2.0 M, conductivity and viscosity of the electrolyte solution may be appropriately maintained.

### First Additive

The first additive according to examples of the present disclosure may be represented by Formula 1 below:

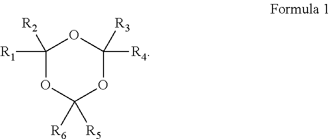

In Formula 1 above, R₁ to R₆ may each independently be or include a hydrogen atom or a substituted or unsubstituted C1 to C10 alkyl group.

For example, in Formula 1, R₁ to R₆ may independently be or include C1 to C10 alkyl groups. For example, in Formula 1, R₁ to R₆ may independently be hydrogen atoms. For example, in Formula 1, at least one of R₁ to R₆ may be or include a C1 to C10 alkyl group, and at least one of R₁ to R₆ may be a hydrogen atom.

In an example embodiment, Formula 1 above may be represented by Formula 1-1 or Formula 1-4 below.

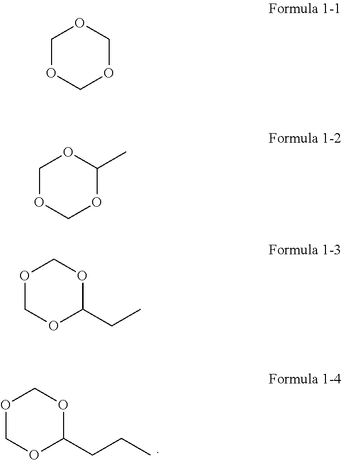

The first additive may be included in an amount of about 0.01 wt % to about 5 wt %, about 0.05 wt % to about 4 wt %, about 0.1 wt % to about 3.5 wt %, or about 0.15 wt % to about 2 wt %. For example, the first additive may amount to about 0.2 wt % to about 1 wt % with respect to the total amount of the electrolyte solution.

When the content of the first additive is less than the above range of about 0.01 wt % to about 5 wt %, a film may not be fully formed on a negative electrode, and when the content of the first additive is greater than the above range about 0.01 wt % to about 5 wt %, batteries may have reduced capacity and lifetime resulting from increased resistance of the negative electrode film due to excessive decomposition reactions.

The first additive may contain trioxane. In the first additive, a film made of trioxane may be formed on a solid-electrolyte interface (SEI) layer containing LiF to form an organic-inorganic composite film. The organic-inorganic composite film may enable a negative electrode to have improved interface stability and life characteristics at high temperatures in a rechargeable lithium battery. Accordingly, the first additive may form an electrochemically stable film on a surface of the negative electrode through a ring-opening reaction, and may thus reduce or suppress dendrite formation. Herein, the “ring-opening reaction” indicates a reaction in which a ring in a cyclic compound is broken to form a chain compound.

### Second Additive

The second additive according to examples of the present disclosure may be or include a compound capable of ring-opening the first additive described above. Herein, the second additive may be or include a catalyst capable of breaking a ring of the first additive, which is a cyclic compound.

For example, the second additive may include at least one of LiBF₄, LiDFOB, NaBF₄, KBF₄, RbBF₄, and CsBF₄. In an example embodiment, the second additive may be or include LiBF₄.

The second additive may be included in an amount of about 0.01 wt % to about 5 wt %, about 0.05 wt % to about 4 wt %, about 0.1 wt % to about 3.5 wt %, or about 0.15 wt % to about 3 wt %. For example, the second additive may amount to about 0.2 wt % to about 1 wt % with respect to the total amount of the electrolyte solution. In a case in which the amount of the second additive is in any of the above ranges, a rechargeable lithium battery with improved lifetime characteristics and output characteristics at high temperatures may be achieved.

A synergistic effect may be generated when the second additive is combined with an additive having a structure containing trioxane (e.g., the first additive described above). The combination of the first additive and the second additive may form an electrochemically stable film on a surface of a negative electrode through a ring-opening reaction to reduce or suppress dendrite formation, and may thus improve the high-temperature cycle and room-temperature cycle stability of batteries.

In the electrolyte solution, the content of the first additive may be the same as

or less than the content of the second additive. Herein, the content of an additive may indicate a weight of an additive included in the electrolyte solution with respect to a total weight of the electrolyte solution.

For example, a ratio of the content of the second additive to the content of the first additive in the electrolyte solution may be about 1 to about 3, about 1 to about 2.5, or about 1 to about 2. In a case in which the content ratio of the first additive to the second additive is less than the above range, a protection film may not be fully formed on a surface of a negative electrode, and, in a case in which the content ratio of the first additive to the second additive is greater than the above range, lifetime capacity and efficiency at high temperatures may be reduced.

According to an example embodiment, as for the first additive and the second additive, the same amount may be used in the electrolyte solution. When the first additive and the second additive are added in similar amounts in the electrolyte solution, with a polymer organic film and an LiF inorganic film formed through a ring-opening reaction of the first additive, a more robust and stable film may be formed on a negative electrode. This may contribute more effectively to the lifetime characteristics of lithium batteries.

In another example embodiment of the present disclosure, a rechargeable lithium battery, which includes a positive electrode including a positive electrode active material, a negative electrode including a negative electrode active material, and an electrolyte solution including a non-aqueous organic solvent, a lithium salt, a first additive represented by Formula 1 described above, and a second additive represented by Formula 2 described above, may be provided. In the electrolyte solution, the content ratio of the second additive to the first additive may be about 1 to about 3.

The rechargeable lithium battery may be applicable to, e.g., automobiles, mobile phones, and/or various types of electric devices, as non-limiting examples.

The positive electrode active material may include a lithium composite oxide represented by Formula 2 below.

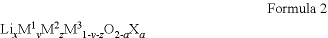

0.5≤x≤1.8, 0≤a≤0.05, 0<y≤1, 0≤z≤1, and 0≤y+z≤1 may be satisfied,

M¹, M², and M³ may each independently include at least one of metals of nickel (Ni), cobalt (Co), manganese (Mn), aluminum (Al), boron (B), barium (Ba), calcium (Ca), cerium (Ce), chromium (Cr), iron (Fe), molybdenum (Mo), niobium (Nb), silicon (Si), strontium (Sr), magnesium (Mg), titanium (Ti), vanadium (V), tungsten (W), zirconium (Zr), and lanthanum (La), and a combination thereof, and

X may include at least one of fluorine (F), sulfur(S), phosphorus (P), or chlorine (Cl).

In one example embodiment, the positive electrode active material of the rechargeable lithium battery may include at least one of lithium cobalt oxide (LCO, LiCoO₂) or lithium iron phosphate (LiFePO₄). In the rechargeable lithium battery using the electrolyte solution according to the present disclosure, the positive electrode active material may include lithium iron phosphate (LiFePO₄).

In the rechargeable lithium battery using the electrolyte solution according to the present disclosure, the negative electrode active material may include at least one of a carbon-based negative electrode active material, a Si-based negative electrode active material, a Sn-based negative electrode active material, or a combination thereof.

In an example embodiment, the Si-based negative electrode active material may be or include a silicon-carbon composite. The Si-based negative electrode active material may include a core containing silicon-based particles and a coating layer containing amorphous carbon. The silicon-based particles may include at least one of silicon particles, a Si—C composite, SiOx (0<×≤2), and a Si alloy.

Hereinafter, Examples and Comparative Examples of the present disclosure will be described. However, the following Examples are presented only as an example embodiment of the present disclosure, and the present disclosure is not limited to Examples below.

### EXAMPLES AND COMPARATIVE EXAMPLES

### (1) Preparation of Electrolyte Solution

1.3 M LiPF₆ was dissolved in a non-aqueous organic solvent in which ethylene carbonate (EC), propylene Carbonate (PC), and propyl propionate (PP) were mixed in a volume ratio of about 10:15:75, and 0.2 wt % of a first additive and 0.2 wt % of a second additive were added to prepare an electrolyte solution.

The compound represented by Formula 1-1 was used as the first additive.

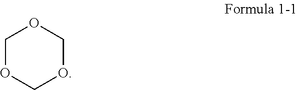

LiBF₄ was used as the second additive.

### (2) Preparation of Rechargeable Lithium Battery

Lithium cobalt oxide (LCO, LiCoO₂) as a positive electrode active material, polyvinylidene fluoride as a binder, and ketjen black as a conductive material were mixed in a weight ratio of 97:2:1, and dispersed in N-methyl pyrrolidone to prepare a positive electrode active material slurry.

The slurry was applied onto a 14 μm thick aluminum current collector, dried at 110° C., and then pressed to prepare a positive electrode.

A mixture of artificial graphite and silicon nanoparticles in a weight ratio of 93:7 as a negative electrode active material, styrene-butadiene rubber (SBR) as a binder, and carboxymethyl cellulose (CMC) as a thickener were mixed in a weight ratio of 97:1:2 and dispersed in distilled water to prepare a negative electrode active material slurry.

The negative electrode active material slurry was applied onto a 10 μm thick copper current collector, dried at 100° C., and then pressed to prepare a negative electrode.

An electrode assembly was prepared by assembling the positive electrode, the negative electrode, and a 25 μm thick polyethylene separator, and the electrolyte solution was injected to prepare a rechargeable lithium battery.

### Example 2

An electrolyte solution and a rechargeable lithium battery were prepared in the same manner as in Example 1, with a difference that 0.5 wt % of the first additive and 0.5 wt % of the second additive were used.

### Example 3

An electrolyte solution and a rechargeable lithium battery were prepared in the same manner as in Example 1, with a difference that 1.0 wt % of the first additive and 1.0 wt % of the second additive were used.

### Example 4

An electrolyte solution and a rechargeable lithium battery were prepared in the same manner as in Example 1, with a difference that 3.0 wt % of the first additive and 3.0 wt % of the second additive were used.

### Example 5

An electrolyte solution and a rechargeable lithium battery were prepared in the same manner as in Example 1, with a difference that 5.0 wt % of the first additive and 5.0 wt % of the second additive were used.

### Example 6

An electrolyte solution and a rechargeable lithium battery were prepared in the same manner as in Example 1, with a difference that 1.0 wt % of the first additive and 2.0 wt % of the second additive were used.

### Example 7

An electrolyte solution and a rechargeable lithium battery were prepared in the same manner as in Example 1, with a difference that a compound represented by Formula 1-3was used instead of the first additive represented by Formula 1-1.

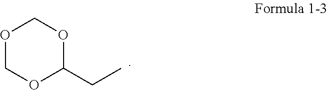

### Example 8

An electrolyte solution and a rechargeable lithium battery were manufactured in the same manner as in Example 1, with a difference that a mixture of lithium cobalt oxide (LiCoO₂) and lithium iron phosphate (LiFePO₄) in a weight ratio of 95:5 was used as the positive electrode active material.

### Comparative Example 1

An electrolyte solution and a rechargeable lithium battery were prepared in the same manner as in Example 1, with a difference that the first additive represented by Formula 1-1 and the second additive (LiBF₄) were not added in the preparation of the electrolyte solution.

### Comparative Example 2

An electrolyte solution and a rechargeable lithium battery were prepared in the same manner as in Example 1, with a difference that 1.0 wt % of the first additive and 0.2 wt % of the second additive were used.

### Comparative Example 3

An electrolyte solution and a rechargeable lithium battery were prepared in the same manner as in Example 1, with a difference that 1.0 wt % of the first additive and 5.0 wt % of the second additive were used.

### Evaluation Example

The rechargeable lithium batteries were evaluated in the following manner.

### Evaluation 1: Evaluation of Penetration

For each rechargeable lithium battery of Examples and Comparative Examples, penetration characteristics were evaluated by penetrating cells at a rate of 250 mm/s with a 3 Φ penetration pin at a state of charge of 50% (SOC 50), a state of charge of 70% (SOC 70), and a state of charge of 100% (SOC 100), and whether ignition was present, recorded and evaluated, and the results are shown in Table 1.

### Evaluation Standard

L0: no change in appearance
L1: leakage
L2: fumes, exothermic at less than 200° C.
L3: fumes, fine spark eruption, exothermic at 200° C.˜400° C.
L4: ignition
L5: explosion, burst

TABLE 1

Result of penetration

| | SOC100 | SOC70 | SOC50 |
|---|---|---|---|
| Comparative | L4 | L4 | L4 |
| Example 1 | | | |
| Comparative | L4 | L4 | L3 |
| Example 2 | | | |
| Comparative | L4 | L4 | L3 |
| Example 3 | | | |
| Example 1 | L3 | L3 | L2 |
| Example 2 | L3 | L2 | L1 |
| Example 3 | L2 | L2 | L1 |
| Example 4 | L2 | L2 | L1 |
| Example 5 | L2 | L2 | L1 |
| Example 6 | L3 | L2 | L1 |
| Example 7 | L2 | L2 | L1 |
| Example 8 | L2 | L1 | L1 |

### Evaluation 2: Evaluation of High Temperature Charge/Discharge Cycle Characteristics

The rechargeable lithium batteries prepared in Examples and Comparative Examples were subjected to 2.0 C charge (CC/CV, 4.53 V cut-off)/1.0° C. discharge (CC, 3.0 V cut-off) at 45° C. for 200 cycles, and then discharge capacity was measured and capacity retention was calculated, and the results are shown in Table 2 below. High temperature retention was calculated according to Equation 1 below.

$$Capacity retention ( \% ) = ( discharge capacity after 200 cycles / initial discharge capacity ) * 100 \qquad Equation 1$$

TABLE 2

| | Capacity |
|---|---|
| Item | retention (%) |
| Comparative | 91.8 |
| Example 1 | |
| Comparative | 92.4 |
| Example 2 | |
| Comparative | 85.6 |
| Example 3 | |
| Example 1 | 93.5 |
| Example 2 | 93.1 |
| Example 3 | 92.9 |
| Example 6 | 92.6 |
| Example 7 | 93.7 |
| Example 8 | 93.4 |

### Comprehensive Evaluation

Referring to Table 1, when using the electrolyte solutions of Examples 1 to 8 containing the first and second additives according to an example embodiment of the present disclosure, Examples 1 to 8 have enhanced penetration stability compared to Comparative Examples.

According to Table 2, Examples using the electrolyte solutions according to an example embodiment of the present disclosure are superior to Comparative Examples in cycle characteristics and lifetime efficiency of rechargeable lithium batteries at high temperatures. In particular, when the first additive and the second additive according to an

example embodiment of the present disclosure are added in similar amounts to an electrolyte solution, as in Examples 1 to 3, a more robust and stable organic-inorganic composite film may be formed on a negative electrode during charging and discharging. Accordingly, in the case above, lithium batteries have further desired or improved stability and high temperature lifetime characteristics.

An electrolyte solution according to an example embodiment uses a combination of a trioxane-based additive and an initiator capable of ring-opening the additive, and may thus produce the effect of improving stability and lifetime characteristics in high-temperature conditions when activating rechargeable batteries.

Although example embodiments of the present disclosure have been described above, the scope of the present disclosure is not limited to the example embodiments. Various modifications of the example embodiments may be made without departing from the spirit and scope of the disclosure as defined by the appended claims, and the modifications are included in the scope of the present disclosure.

What is claimed is:

1. An electrolyte solution for a rechargeable lithium battery, the electrolyte solution comprising:
a non-aqueous organic solvent;
a lithium salt;
a first additive represented by Formula 1 below; and
a second additive capable of ring-opening the first additive,
wherein the content ratio of the second additive to the first additive is about 1 to about 3, 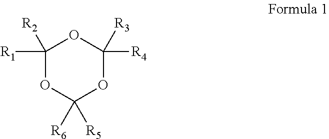
wherein in Formula 1 above, R₁ to R₆ each independently comprise one of a hydrogen atom and a substituted or unsubstituted C1 to C10 alkyl group.

2. The electrolyte solution for a rechargeable lithium battery of claim 1, wherein the first additive is represented by Formulas 1-1 to 1-4 below:

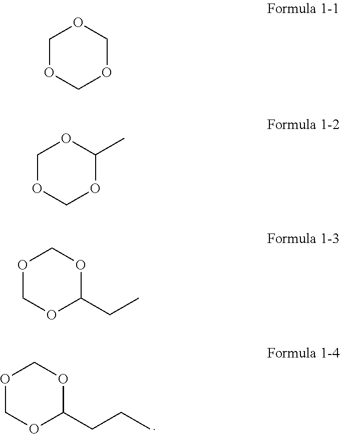

3. The electrolyte solution for a rechargeable lithium battery of claim 1, wherein the first additive has a concentration of about 0.01 wt % to about 5 wt % of a total weight of the electrolyte solution.

4. The electrolyte solution for a rechargeable lithium battery of claim 1, wherein the second additive comprises at least one of LiBF₄, LiDFOB, NaBF₄, KBF₄, RbBF₄, and CsBF₄.

5. The electrolyte solution for a rechargeable lithium battery of claim 1, wherein the second additive has a concentration of about 0.01 wt % to about 5 wt % of a total weight of the electrolyte solution.

6. The electrolyte solution for a rechargeable lithium battery of claim 1, wherein the non-aqueous organic solvent comprises a carbonate-based solvent, and
the carbonate-based solvent comprises at least one of ethylene carbonate (EC), propylene carbonate (PC), propyl propionate (PP), ethyl methyl carbonate (EMC), dimethyl carbonate (DMC), diethyl carbonate (DEC), dipropyl carbonate (DPC), methylpropyl carbonate (MPC), ethylpropyl carbonate (EPC), methylethyl carbonate (MEC), and butylene carbonate (BC).

7. The electrolyte solution for a rechargeable lithium battery of claim 1, wherein the non-aqueous organic solvent comprises ethylene carbonate (EC), propylene carbonate (PC), and propyl propionate (PP), and
wherein the ethylene carbonate (EC), the propylene carbonate (PC), and the propyl propionate (PP) are present at a volume ratio of 1:a:b, where:
“a” is in a range of 1 to 3, and
“b” is in a range of 5 to 8.

8. The electrolyte solution for a rechargeable lithium battery of claim 1, wherein the lithium salt comprises at least one of LiPF₆, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N, (lithium bis (fluorosulfonyl) imide (LiFSI)), and LiC₄F₉SO₃.

9. The electrolyte solution for a rechargeable lithium battery of claim 1, wherein the lithium salt has a concentration of about 0.1 M to about 2.0 M.

10. A rechargeable lithium battery comprising:
a positive electrode including a positive electrode active material;
a negative electrode including a negative electrode active material; and
the electrolyte solution of claim 1.

11. The rechargeable lithium battery of claim 10, wherein the positive electrode active material comprises a lithium composite oxide represented by Formula 2 below:
$${Li}_{x} {M}_{y}^{1} {M}_{z}^{2} {M}_{1 - y - z}^{3} {O}_{2 - a} {X}_{a} \qquad Formula 2$$
wherein:
0.5≤x≤1.8, 0≤a≤0.05, 0<y≤1, 0≤z≤1, and 0≤y+z≤1 are satisfied,
M¹, M², and M³ each independently include at least one of nickel (Ni), cobalt (Co), manganese (Mn), aluminum (Al), boron (B), barium (Ba), calcium (Ca), cerium (Ce), chromium (Cr), iron (Fe), molybdenum (Mo), niobium (Nb), silicon (Si), strontium (Sr), magnesium (Mg), titanium (Ti), vanadium (V), tungsten (W), zirconium (Zr), or lanthanum (La), and a combination thereof, and
X includes at least one of fluorine (F), sulfur(S), phosphorus (P), or chlorine (CI).

12. The rechargeable lithium battery of claim 10, wherein the positive electrode active material comprises lithium iron phosphate (LiFePO₄).

13. The rechargeable lithium battery of claim 10, wherein the negative electrode active material comprises at least one of a carbon-based negative electrode active material, a Si-based negative electrode active material, and a Sn-based negative electrode active material.

14. The rechargeable lithium battery of claim 10. wherein the rechargeable lithium battery is one of a cylindrical battery, a prismatic battery, a pouch-type battery, and a coin-type battery.
